(19) United States
(12) Patent Application Publication
(10) Pub. No.: US 2011/0319113 A1
(43) Pub. Date: Dec. 29, 2011

(54) BASE STATION APPARATUS AND INFORMATION TRANSMITTING METHOD

(75) Inventors: Kazuaki Takeda, Tokyo (JP); Satoshi Nagata, Kanagawa (JP); Yoshihisa Kishiyama, Kanagawa (JP); Nobuhiko Miki, Yokohama-shi, Kanagawa (JP); Mamoru Sawahashi, Kanagawa (JP)

(73) Assignee: NTT DOCOMO, INC., Tokyo (JP)

(21) Appl. No.: 13/256,261

(22) PCT Filed: Mar. 10, 2010
(86) PCT No.: PCT/JP2010/054007

§ 371 Date: Sep. 13, 2011

(30) Foreign Application Priority Data
Mar. 16, 2009 (JP) 2009-063595

(51) Int. Cl. H04W 72/08

(52) U.S. Cl. 455/509

(57) ABSTRACT

Provided are a base station apparatus and an information transmitting method capable of enhancing frequency diversity effect and improving reception quality characteristics at a mobile terminal apparatus even when a system bandwidth is extended. The information transmitting method comprises: using reception quality information from the mobile terminal apparatus as a basis to select one or more than one group band from a set of group bands obtained by dividing a system band (ST302), selecting schedule information by comparing data rates of an overall system obtained after allocating transmission data to the group bands (ST309, ST310); and transmitting the transmission data scheduled in accordance with the schedule information to the mobile terminal apparatus on downlink.

### TECHNICAL FIELD

The present invention relates to a base station apparatus and an information transmitting method, and particularly, to abase station apparatus and an information transmitting method using next generation mobile communication technology.

### BACKGROUND ART

In the UMTS (Universal Mobile Telecommunications System) network, in order to enhance frequency use efficiency and improve data rate HSDPA (High Speed Downlink Packet Access) or HSUPA (High Speed Uplink Packet Access) has been adopted to draw the best out of characteristics of the W-CDMA (Wideband Code Division Multiple Access) based system. As to this UMTS network, LTE (Long Term Evolution) has been considered to achieve higher-speed data rates and reduction in delay.

The 3^{rd} generation systems generally use a fixed band of 5 MHz and can realize a transmission rate of about 2 Mbps on the downlink. On the hand, in the LTE system, a variable band of about 1.4 MHZ to 20 MHz is used to realize a downlink transmission rate of 300 bps at the maximum and an uplink transmission rate of 75 bps. Besides, in the UMT network, in order to achieve a much broader band and higher speed, consideration is given to a successor to the LTE system (hereinafter referred to as “broadband radio communication system” appropriately) (for example, LTE Advanced (LTE-A)). For example, in the LTE-A system, it is expected that the LTE's maximum system band 20 MHz is extended to about 100 MHz.

Besides, in the LTE system, a multi antenna radio transmission technology such as MIMO (Multiple Input Multiple Output) is adopted to realize high-speed signal transmission by parallel-transmitting different transmission signals via plural transmitters with use of the same radio resources (frequency bands and time slots) and multiplexing them spatially. In the LTE system, different transmission signals are parallel-transmitted from four transmission antennas at the maximum and multiplexed spatially. In the LTE-A system, the maximum number (four) of transmission antennas of the LTE system is planned to be increased up to eight.

Here, when there is a transmission error in information bit in the LTE system, a retransmission request (repeat request) is performed at a receiver side and retransmission control is performed by a transmitter in response to this retransmission request. In this case, the number of blocks as unit of retransmission in retransmission control (hereinafter referred to as “transport blocks”) is determined in accordance with the number of transmission antennas, irrespective of the system bandwidth (see, for example, NPL1 to NPL3). Here, description is made about relationships between the system bandwidth and the number of transmission antennas in the LTE system and the number of transport blocks (TB) and transport block size. FIG. 11 is a table illustrating relationships between the system bandwidth and number of transmission antennas in the LTE system and the number of transport blocks and transport block size. Here, in FIG. 11, the system bandwidths illustrated are 1.4 MHz, 5 MHz, 10 MHz and 20 MHz. Besides, the “layer” illustrated in FIG. 11 corresponds to the number of transmission antennas. As illustrated in FIG. 11, in the LTE systems, if there is one transmission antenna, the set number of transport blocks is one irrespective of the system bandwidth. Likewise, when there are two transmission antennas, the set number of transport blocks is two, and when there are four transmission antennas, the set number of transport blocks is also two. That is, when the number of transmission antennas is equal to or greater than two, the set number of transport blocks is two uniformly.

### CITATION LIST

### Non Patent Literature

Non Patent Literature 1: 3GPP, TS 36.211 (V.8.4.0), “Evolved Universal Terrestrial Radio Access (E-UTRA); Physical Channels and Modulation (Release 8)”, Sep.2008F Non Patent Literature 2: 3GPP, TS 36.212 (V.8.4.0), “Evolved Universal Terrestrial Radio Access (E-UTRA); Multiplexing and channel coding (Release 8)”, Sep. 2008 Non Patent Literature 3: 3GPP, TS 36.213 (V.8.4.0), “Evolved Universal Terrestrial Radio Access (E-UTRA); Physical layer procedures (Release 8)”, Sep. 2008

### SUMMARY OF THE INVENTION

### Technical Problem

As described above, in the broadband radio communication systems, notably LTE-A system, it is expected that the maximum system bandwidth is extended to about 100 MHz and the maximum number of transmission antennas is increased up to eight. In the thus system band extended next generation mobile communication systems, there seems to be a demand that the transmission system of transmission data is determined considering the reception quality in a mobile terminal apparatus.

The present invention was carried out in view of the foregoing, and has an object to provide a base station apparatus and an information transmitting method capable of improving the frequency diversity effect and enhance reception quality characteristics even when the system bandwidth is extended.

### SOLUTION TO PROBLEM

The present invention provides a base station apparatus that comprises: scheduling section configured to use reception quality information from a mobile terminal apparatus as a basis to select one or more than one group band from a set of group bands which is provided by dividing a system band and comparing data rates of an overall system obtained after allocating of transmission data to the group bands thereby to select schedule information; and transmitting section configured to transmit the transmission data which is scheduled in accordance with the schedule information to the mobile terminal apparatus on downlink.

According to this structure, as the schedule information is selected considering not only the reception quality information from the mobile terminal apparatus and data rates of the overall system obtained after allocating the transmission data to group bands selected based on the reception quality information, it is possible to assign optimal group bands in the system band to the mobile terminal, thereby enhancing the frequency diversity effect even when the system bandwidth is extended and improving the reception quality characteristics in the mobile terminal apparatus.

### TECHNICAL ADVANTAGE OF THE INVENTION

According to the present invention, the schedule information is selected in consideration of not only the reception quality information from the mobile terminal apparatus but also data rate of the overall system obtained after transmission data is allocated to the group bandwidth selected based on the reception quality information. With this structure, it is possible to assign an optimal group band in the system band to the mobile terminal apparatus and therefore, to enhance the frequency diversity effect and improve the reception quality characteristics in the mobile terminal apparatus even when the system bandwidth is extended.

### BRIEF DESCRIPTION OF DRAWINGS

FIG. 1 is a view for explaining a state of use of frequencies in downlink mobile communications;

FIG. 2 is a schematic diagram for explaining a method for allocating transport blocks in a base station apparatus according to an embodiment of the present invention;

FIG. 3 is a flowchart for explaining the processing of allocating transport blocks at the base station apparatus according to the above-mentioned embodiment;

FIG. 4 is a view for explaining the step of calculating an average of CQI in allocating transport blocks at the base station apparatus according to the above-mentioned embodiment;

FIG. 5 is a schematic diagram for explaining a state of the system band when optimal schedule information is selected in accordance with data rates based on two group bands at the base station apparatus according to the above-mentioned embodiment;

FIG. 6 is a view for explaining a configuration of a mobile communication system having the base station apparatus and a mobile terminal apparatus according to the above-mentioned embodiment;

FIG. 7 is a block diagram illustrating a configuration of the base station apparatus according to the above-mentioned embodiment;

FIG. 8 is a functional block diagram of a baseband signal processing section provided in the base station apparatus according to the above-mentioned embodiment;

FIG. 9 is a block diagram illustrating a configuration of the mobile terminal apparatus according to the above-mentioned embodiment;

FIG. 10 is a functional block diagram of a baseband signal processing section provided in the mobile terminal apparatus according to the above-mentioned embodiment; and

FIG. 11 is a view of a table illustrating a relation between the number of transmission antennas and system bandwidth and the number of transport blocks and transport block size in the LTE systems.

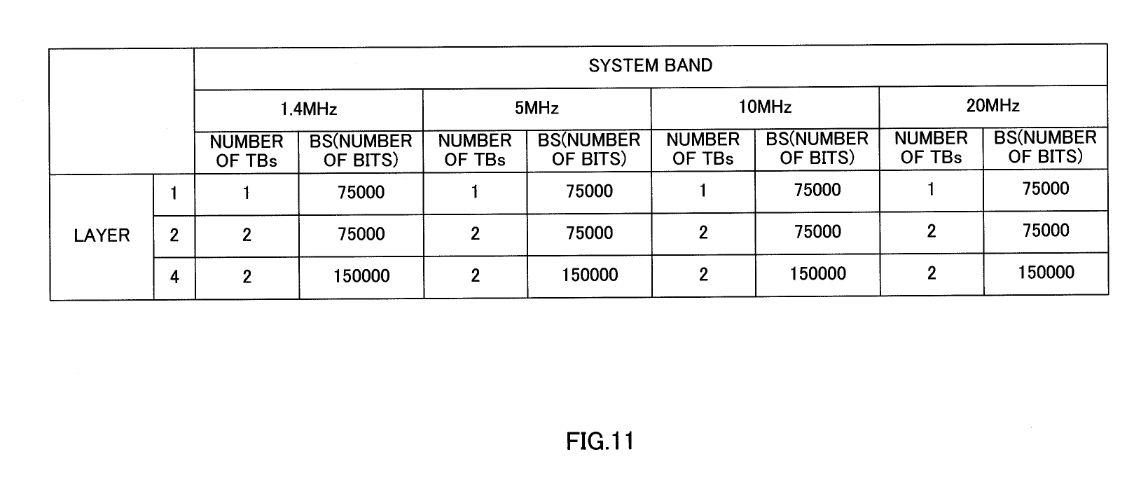

### DESCRIPTION OF EMBODIMENTS

With reference to the attached drawings, embodiments of the present invention will be described in detail below. Here, in the following description, the LTE-A (LTE advanced) system (hereinafter referred to as “LTE-A system”) is referred to as one example of a succeeding broadband radio access system to LTE, however, this is not intended for limiting the present invention. For example, it includes a succeeding broadband radio communication system to this LTE-A system.

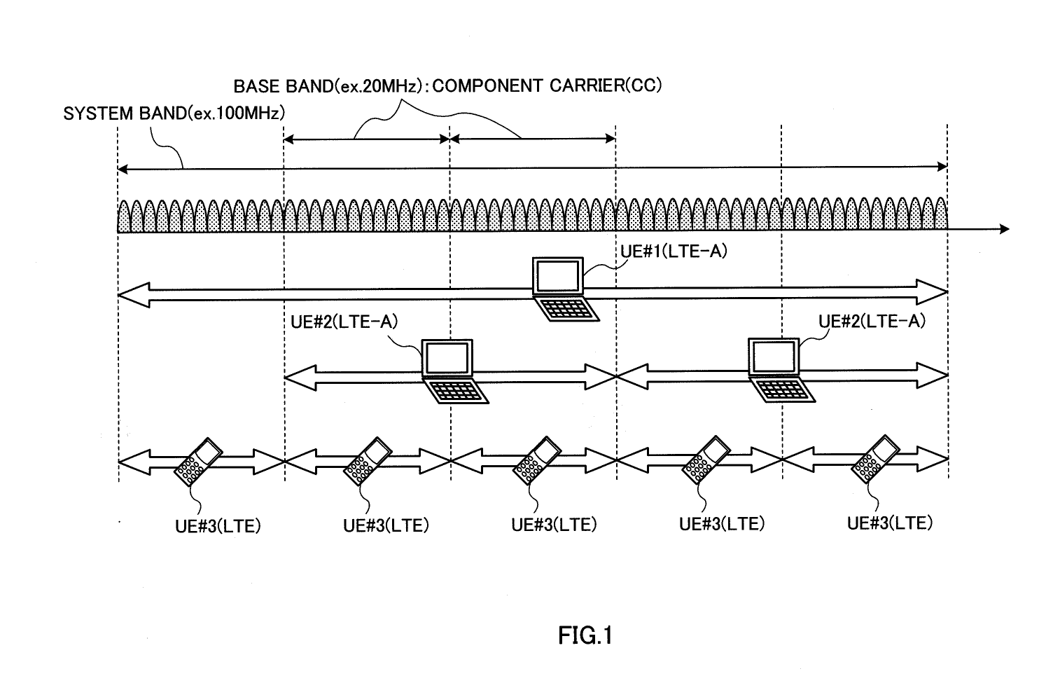

FIG. 1 is a view for explaining a state of use of frequencies in downlink mobile communications. In the state of use of frequencies of FIG. 1, there exist an LTE-A system as a mobile communication system having a system band composed of plural component carriers and an LTE system as a mobile communication system having a system band composed of one component carrier. In the LTE-A system, for example, radio communications are performed at a variable system bandwidth of 100 MHz or less and in the LTE system, radio communications are performed at a variable system bandwidth of 20 MHz or less. The system band of the LTE-A system includes at least one fundamental frequency area (CC: component carrier) each of which is a system band of the LTE system. In this way, the plural fundamental frequency areas aggregate to establish a broadband, which is called carrier aggregation.

For example, in FIG. 1, the system band of the LTE-A system includes five component carriers each of which is a system band of the LTE system (base band: 20 MHz) (20 MHz×5=100 MHz). In FIG. 1, UE (User Equipment) #1 is a LTE-A system compatible (also LTE system compatible) mobile terminal apparatus having a system band of 100 MHz, UE #2 is an LTE-A system compatible (also LTE system compatible) mobile terminal apparatus having a system band of 40 MHz (20 MHz×2=40 MHz) and UE #3 is an LTE system compatible (not LTE-A system compatible) mobile terminal apparatus having a system band of 20 MHz (base band).

In this way, when allocating transport blocks each as a unit of retransmission in an environment where the system band is composed of plural component carriers (CCs) and there exist mobile terminal apparatuses UE having different transmission/reception bandwidths, for example, CCs to allocate transport blocks are selected based on an average of SINR (Signal-to-Interference-plus-Noise Ratio), and scheduling of transmission data is performed for the selected CC to achieve an optimal data rate. In this case, the frequency diversity effect in a single CC can be obtained. However, it is difficult to obtain the maximum frequency diversity effect that can be obtained in a broad system band, or the maximum frequency diversity effect that can be obtained in a system band composed of plural CCs.

In a mobile communication system according to the present embodiment, in an environment where the system band is composed of plural CCs and there exist mobile terminal apparatuses UE having different transmission/reception bandwidths, the frequency diversity effect in resending transmission data to each mobile terminal apparatus UE is enhanced thereby to improve reception quality characteristics in the mobile terminal apparatus UE. Specifically, out of a set of group bands (for example, CCs) obtained by dividing the system band, one or more than one specific group band is selected based on reception quality information from a mobile terminal apparatus UE, and schedule information is determined by comparing data rates of the overall system obtained after allocating the transmission data to the group band(s), thereby enhancing the frequency diversity effect and improving the reception quality characteristics at the mobile terminal apparatus UE. Here, the following description is made about a case where the present invention applies to retransmission control of transmission data at the base station apparatus Node B, however, this is not intended for limiting the present invention. The present invention is also applicable to transmission control in first transmission of the transmission data.

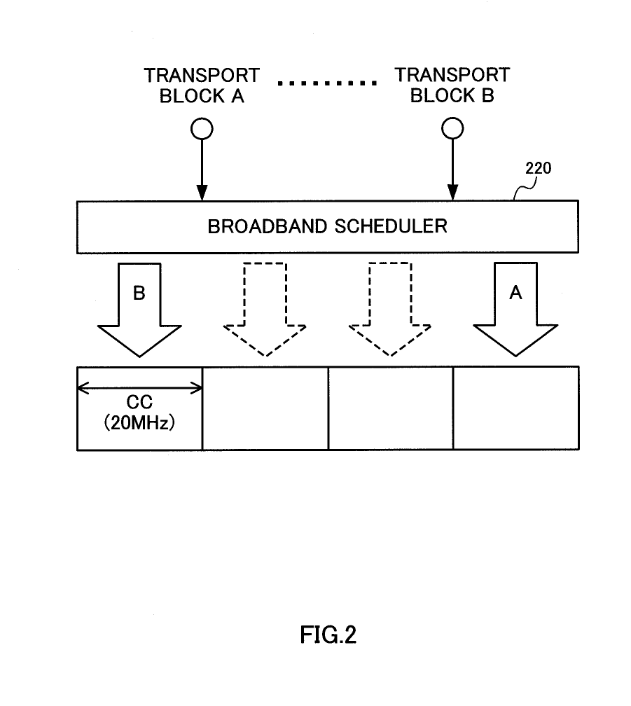

The following description is made about the outlines of the processing of allocating transport blocks in retransmission control at the base station apparatus Node B according to the present embodiment. FIG. 2 is a schematic diagram for explaining a method for allocating transport blocks at the base station apparatus Node B according to the present embodiment. Here, in FIG. 2, the group band is composed of a CC by way of example.

As illustrated in FIG. 2, in the method for allocating transport blocks at the base station apparatus Node B, a broadband scheduler 220 described later generally selects specific CCs based on reception quality information and data rates in plural CCs composed of the system band and performs scheduling of transmission data composed of transport blocks to RB composed of the CCs. In this method of allocating transport blocks, not only the reception quality information from the mobile terminal apparatus UE but also data rates in plural CCs that make up the system band are considered. With this method, the frequency diversity effect can be enhanced as compared with the case where scheduling of transmission data is performed in such a manner as to achieve the optimal throughput in CCs selected based on average SINR and the like. Particularly, in the example of FIG. 2, as a CC is selected as a unit to allocate transport blocks, it is possible to achieve an affinity to the LTE system.

Here, in the method of allocating transport blocks illustrated in FIG. 2, a group band is a CC (for example, 20 MHz), however, the bandwidth of the group band is not limited to this width and may be modified appropriately. For example, the group band may be narrower or broader than a CC.

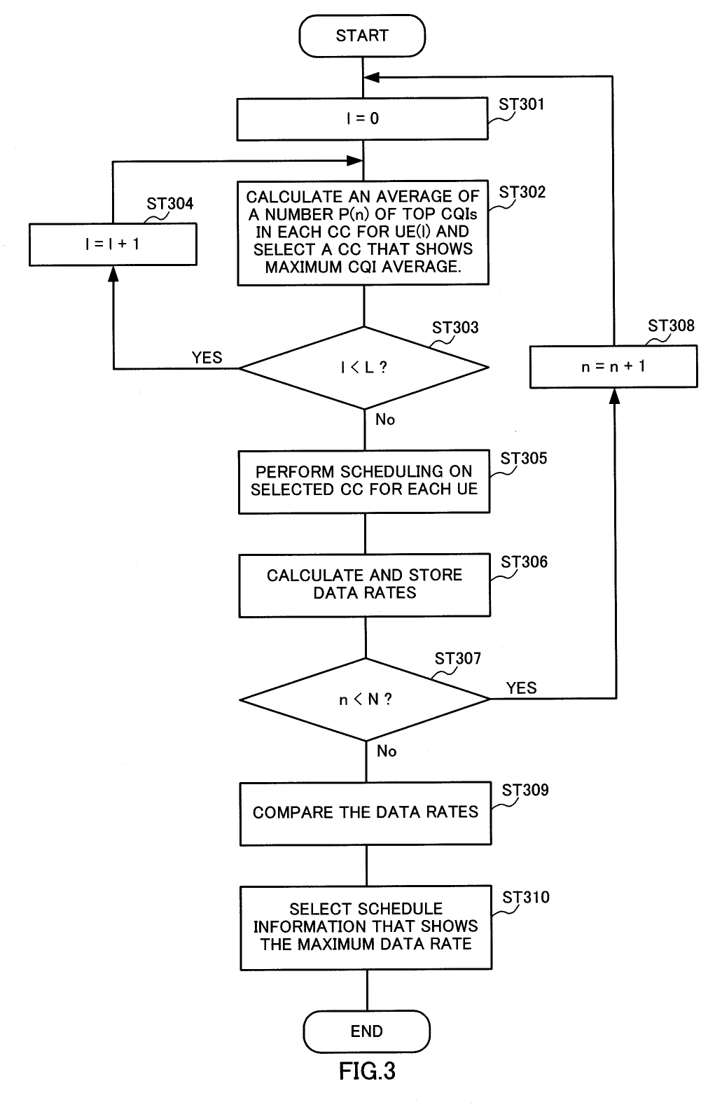

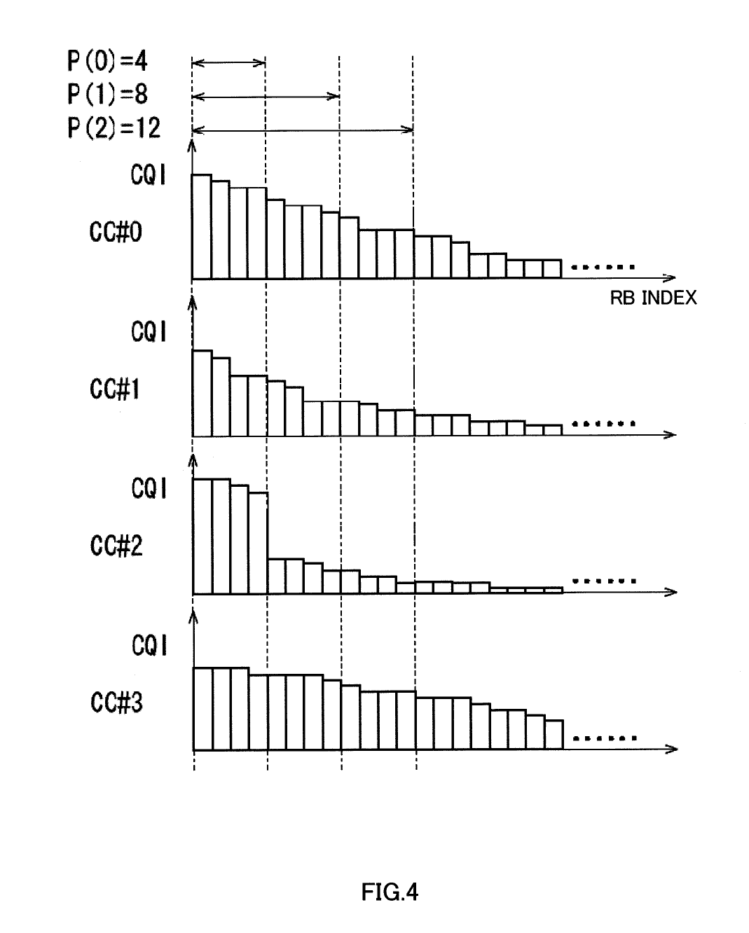

Here, FIGS. 3 and 4 are used to explain the processing of the base station apparatus Node B in allocating transport blocks in this way. FIG. 3 is a flowchart for explaining the processing of allocating transport blocks at the base station apparatus Node B according to the present invention. FIG. 4 is a view for explaining the step of calculating an average of CQI in allocating transport blocks at the base station apparatus Node B according to the present invention. Here, like in FIG. 2, it is assumed that the group band is a CC. Also, before starting the processing illustrated in FIG. 3, the base station apparatus Node B has obtained a CQI of each CC (more specifically, CQI in a RB of the CC) at the downlink from all mobile terminal apparatuses UE as communication target.

In FIG. 3, “1” is a number that represent a current processing target of mobile terminal apparatuses UE (processing target number) and “L” is a total number of mobile terminal apparatuses UE as processing targets.

Besides, represents a pattern number determined associated with CQI averages and “N” represents a total number of patterns. In a state before the processing of FIG. 3 starts, the pattern number n stands at “0”. Further, the pattern number “n” ranges from “0” to “2” and when the pattern numbers are 0, 1 and 2, the number of CQIs used in average calculation is four, eight and twelve, respectively. Here, these numbers are given by way of example and are not intended for limiting the present invention.

As illustrated in FIG. 3, in allocating transport blocks, first, a processing target number 1 of a mobile terminal apparatus UE as processing target is initialized (1=0) at the base station apparatus Node B (step ST301). Then, for this mobile terminal apparatus UE(1), an average of CQI of higher P (n) RBs of respective CCs and a CC of maximum average is selected (step ST302). As CC selection is performed in accordance with an optimal average of predetermined number of CQIs, it is possible to select a suitable CC for the mobile terminal apparatus UE in the overall system band. Here, in this case, CQI averages of higher four RBs of respective CCs as P(0) and a CC of maximum average is selected.

For example, as illustrated in FIG. 4, when there exist CC #0 to CC #3 as system band and CQI averages of higher four RB are obtained (that is n=0) , the CC #2 is selected. Likewise, when CQI averages of higher eight RBs are obtained (that is, n=1), the CC #0 is selected. When CQI averages of higher twelve RBs are obtained (that is, n=2), the CC #0 is selected. In this way, selected CCs are changed in accordance with the number of CQIs to use in average calculation.

Then, in order to perform such CC selection for all mobile terminal apparatuses UE(1), the base station apparatus Node B determines whether or not the processing target number 1 is smaller than the total number L of mobile terminal apparatuses UE (step ST303). When the current processing target number 1 is smaller than the total number L of mobile terminal apparatuses UE, the processing target number 1 is counted up (step ST304), the processing goes back to ST302, CQI averages of higher P(n) RBs of each CC is performed again for the mobile terminal apparatus UE(1) of the counted up processing target number 1 and a CC of maximum average is selected.

The processing of steps ST302 to ST304 is repeated and when the processing target number 1 is not smaller than the total number L of mobile terminal apparatuses UE at step ST303 (that is, when the CC selection is finished as to all mobile terminal apparatuses UE as processing target), scheduling of transmission data to selected CC for each mobile terminal apparatus UE is performed (step ST305). After this scheduling, the transmission data for each mobile terminal apparatus UE can be allocated in such a manner that the throughput becomes highest for RBs of the selected CC.

Next, the base station apparatus Node B calculates a data rate of the transmission data after scheduling and stores the obtained data rate (step ST306). Here, the calculating method of the data rate in this case is not limited particularly and may adopt any standard. For example, the CQI, SINR or MCS (Modulation and Coding Scheme) may be adopted as calculation standard. When data rate calculation is performed with CQI as standard, for example, such a data rate can be calculated by obtaining a sum of CQIs of RBs of each CC.

Then, in order to perform calculation processing of data rates for all patterns, the base station apparatus Node B determines whether or not the current pattern number n is smaller than the total number N of patterns (step ST307). If the current pattern number n is smaller than the total number N of patterns, the pattern number n is counted up (step ST308), the processing goes back to the step ST301, the data rate calculation is performed in the pattern number n after counting up and its calculation result is stored (steps ST301 to ST306).

By such repetition of processing of steps ST301 to ST308, a data rate obtained based on CQI averages of higher four RBs of the CCs as P(0), a data rate obtained based on CQI averages of higher eight RBs of the CCs as P(1) and a data rate obtained based on CQI averages of higher twelve RBs of the CCs as P(2) are calculated and stored.

Then, through repetition of the processing of these steps ST301 to ST308, if the current pattern n is not smaller than the total number N of patterns at the step ST307 (that is, calculation and storing of the data rates of all patterns are finished), the plural (three in this description) data rates stored at ST306 are compared (step ST309). Then, the base station apparatus Node B selects schedule information that shows highest data rate in accordance with the comparison result (step ST310).

Thus, as the CCs are selected for each mobile terminal apparatus based on averages of higher four, eight and twelve CQIs of each CC in this way, scheduling of the transmission data to the CC is performed and then, schedule information that shows the highest data rate is selected by comparing data rates, it is possible to enhance the frequency diversity effect as holding a higher data rate as compared with the case where transmission data is scheduled in such a manner as to obtain the highest throughput in CCs selected based on SINR average or the like (scheduling is performed within a single CC). Consequently, it is possible to improve the reception quality characteristics in the mobile terminal apparatus UE.

Here, if the group band is narrower or broader than a CC, the portion indicated by “CC” in FIGS. 3 and 4 is replaced with a “group band”. Besides, when the group band is narrower than a CC and the group band is smaller than a band assigned in retransmission control for a mobile terminal apparatus, in the step ST302, plural group bands are selected in ascending order of CQI average and optimal schedule information is selected in accordance with data rates calculated based on the selected plural group bands. For example, when a group band is 10 MHz and maximum band assigned to a mobile terminal apparatus UE is 20 MHz, two group bands of higher CQI averages are selected, and optimal schedule information is selected in accordance with data rates calculated based on these two group bands.

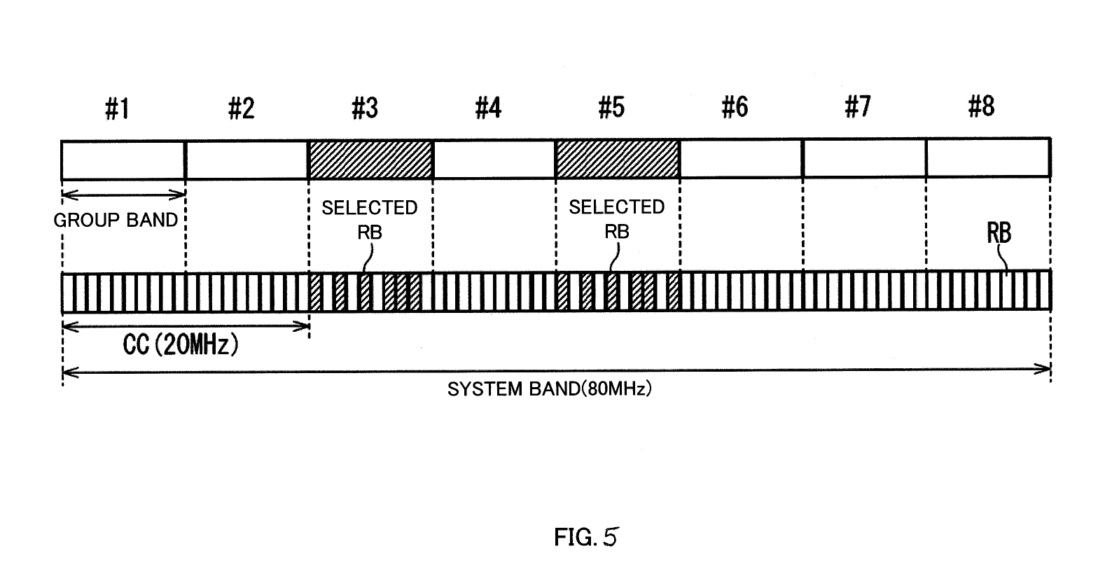

FIG. 5 is a schematic diagram for explaining a state of the system band when optimal schedule information is selected in accordance with data rates of two group bands. In FIG. 5, description is made about the case where the system bandwidth of the mobile communication system is 80 MHz and a band of 20 MHz at the maximum is assigned to each mobile terminal apparatus UE in resending transmission data. Besides, the number of group bands assigned to a mobile terminal apparatus UE is restricted to two.

As illustrated in FIG. 5, the system band is divided into plural group bands (group bands #1 to #8) each of which is 10 MHz. In this case, in the base station apparatus Node B, two group bands are selected in the above-mentioned step ST302 and data rates obtained when transmission data is assigned to these two group bands are compared thereby to determine schedule information. In FIG. 5, the group bands #3 and #5 are selected and the transmission data is scheduled to RBs that make up these group bands. In this case, as the transmission data can be scheduled to group bands that fall within different CCs, the frequency diversity effect can be enhanced as compared with the case where scheduling is performed within a CC, and the reception quality characteristics at the mobile terminal apparatus UE can be improved further.

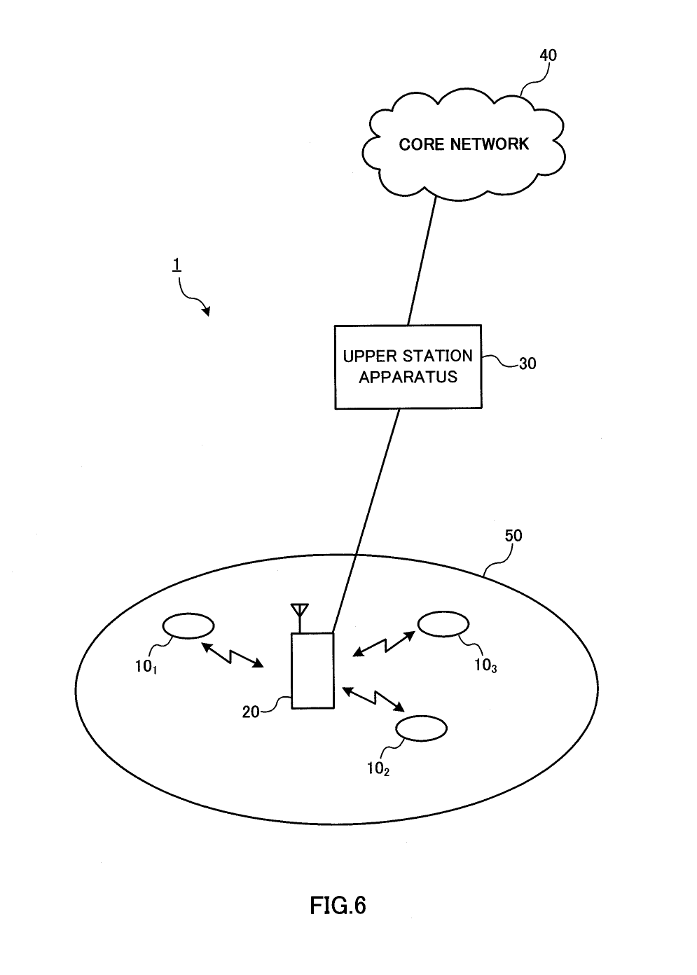

The following description is made about an example of the present invention, with reference to the drawings. With reference to FIG. 6, a mobile communication system 1 having a base station apparatus (Node B) 20 and a mobile terminal apparatus (UE) 10 according to the example of the present invention is described. FIG. 6 is a view for explaining a configuration of the mobile communication system 1 having the base station apparatus 20 and the mobile terminal apparatus 10 according to the present embodiment. Here, the mobile communication system 1 illustrated in FIG. 6 is a system including, for example, Evolved UTRA and UTRAN (LTE: Long term Evolution) or SUPER 3G. Further, this mobile communication system 1 may be called IMT-Advanced or 4G.

As illustrated in FIG. 6, the mobile communication system 1 has abase station apparatus 20 and plural mobile terminal apparatuses 10 (10₁, 10₂, 10₃, . . . , 10ₙ, n is a positive integer). The base station apparatus 20 is connected to a higher level apparatus 30, which is connected to a core network 40. The mobile terminal apparatuses 10 communicate with the base station apparatus 20 in a cell 50 by the Evolved UTRA and UTRAN. Here, the higher level apparatus 30 includes, for example, an access gateway apparatus, a radio network controller (RNC) and a mobility management entity (MME), which are not intended for limiting the present invention.

Here, the mobile terminal apparatuses (10₁, 10₂, 10₃, . . . , 10ₙ) have the same structures, functions and sates, and therefore, these are indicated by the mobile terminal apparatus 10 collectively in the following description except where specifically noted. Besides, for convenience of explanation, it is a mobile terminal apparatus 10 that perform radio communications with the base station apparatus 20, and more generally, it may be a user apparatus (UE: User Equipment) containing the mobile terminal apparatus and a fixed terminal apparatus.

In the mobile communication system 1, the used downlink radio access system is OFDMA (Orthogonal Frequency Division Multiple Access) and the used uplink radio access system is SC-FDMA (Single-Carrier Frequency-Division Multiple. Access). As described above, OFDMA is a multicarrier transmission system in which a frequency band is divided into plural narrower frequency bands (sub carriers) and data is mapped to each sub carrier for communications. SC-FDMA is a single carrier transmission system in which a system band is bands composed of one or successive resource blocks for each terminal and plural terminals use different bands thereby to reduce interference between the terminals.

Here, description is made about a communication channel in Evolved UTRA and UTRAN. For the downlink, a PDSCH (Physical Downlink Shared Channel) shared by mobile terminal apparatuses 10 and a physical downlink control channel (downlink L1/L2 control channel) are used. This PDSCH is used to transmit user data, that is, regular data signals. Transmission data is included in this user data. Here, the schedule information containing CCs and group bands assigned to mobile terminal apparatuses 10 at the base station apparatus 20 is transmitted to the mobile terminal apparatuses 10 on the physical downlink control channel.

In the uplink, a PUSCH (Physical Uplink Shared Channel) shared by mobile terminal apparatuses 10 in and a PUCCH (Physical Uplink Control Channel) as a control channel of the uplink are used. This PUSCH is used to transmit user data, that is, regular data signals. The PUCCH is used to transmit downlink CQI (Channel Quality Indicator) and the like.

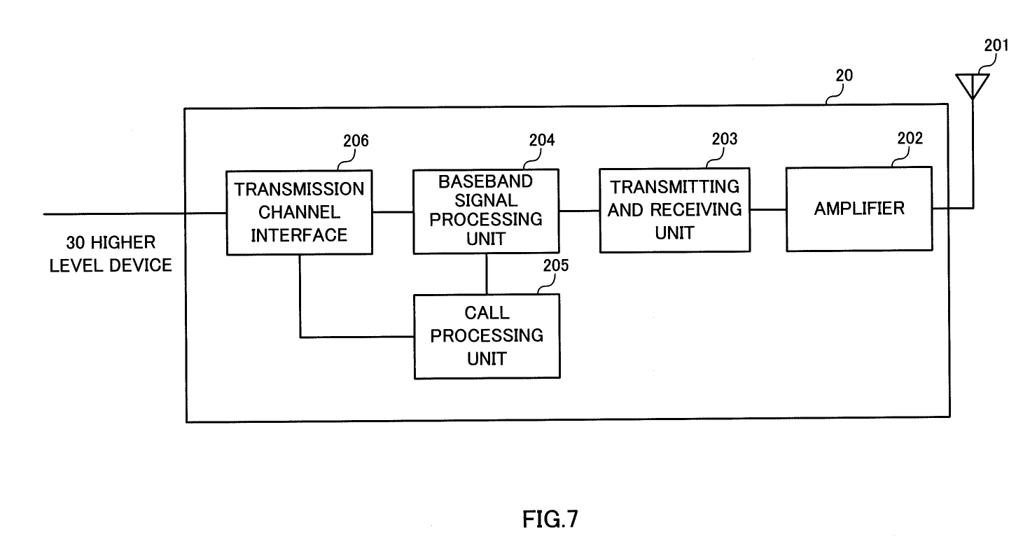

Here, description is made with reference to FIG. 7 about a configuration of the base station apparatus 20 according to the present embodiment. As illustrated in FIG. 7, the base station apparatus has a transmitting and receiving antenna 201, an amplifier 202, a transmitting and receiving section 203, a baseband signal processing section 204, a call processing section 205 and a transmission channel interface 206.

The user data transmitted to the mobile terminal apparatus 10 from the base station apparatus 20 at the downlink is input from the higher level apparatus 30 positioned at a higher level than the base station apparatus 20 to the base band signal processing section 204 via the transmission channel interface 206.

In the baseband signal processing section 204, data is subjected to processing of PDCP layer, division and linking of user data, transmission processing of RLC layer such as transmission processing of RLC (Radio Link Control) retransmission control, retransmission control of MAC (Medium Access Control), for example, transmission processing of HARQ (Hybrid Automatic Repeat reQuest), scheduling, selecting of transmission format, channel coding, inverse Fast Fourier Transform (IFFT) processing and precoding processing and transferred to the transmitting and receiving section 203. Also, as to signals of the physical downlink control channel as downlink control channel, they are subjected to transmission processing such as channel coding and inverse fast Fourier transform and transferred to the transmitting and receiving section 203.

Besides, the baseband signal processing section 204 sends control information for communication in the cell 50 to the mobile terminal apparatus 10 by a broadcast channel. The broadcast information for communication in the cell contains, for example, system bandwidth in the uplink or downlink, identification information of root sequence (Root sequence Index) for generating random access preamble signals in PRACH.

In a transmitting and receiving section 203, the baseband signal output from the baseband signal processing section 204 is subjected to frequency conversion for converting into a radio frequency range signal. Then, the signal is amplified at the amplifier 202 and transmitted via the transmitting and receiving antenna 201. The transmission function of this transmitting and receiving section 203 forms transmitting section.

On the other hand, as to data transmitted from the mobile terminal apparatus 10 to the base station apparatus 20 on the uplink, a radio frequency signal received by the transmitting and receiving antenna 201 is amplified by the amplifier 202, subjected to frequency conversion into a baseband signal by the transmitting and receiving section and input to the baseband signal processing section 204.

In the baseband signal processing section 204, user data contained in the input baseband signal is subjected to FFT processing, IDFT processing, error correction decoding, reception processing of MAC retransmission control, RLC layer and PDCP layer reception processing and transferred to the higher level apparatus 30 via the transmission channel interface 206.

The call processing section 205 performs call processing of settings of communication channels and release, status control of the base station apparatus 20 and management of radio resources.

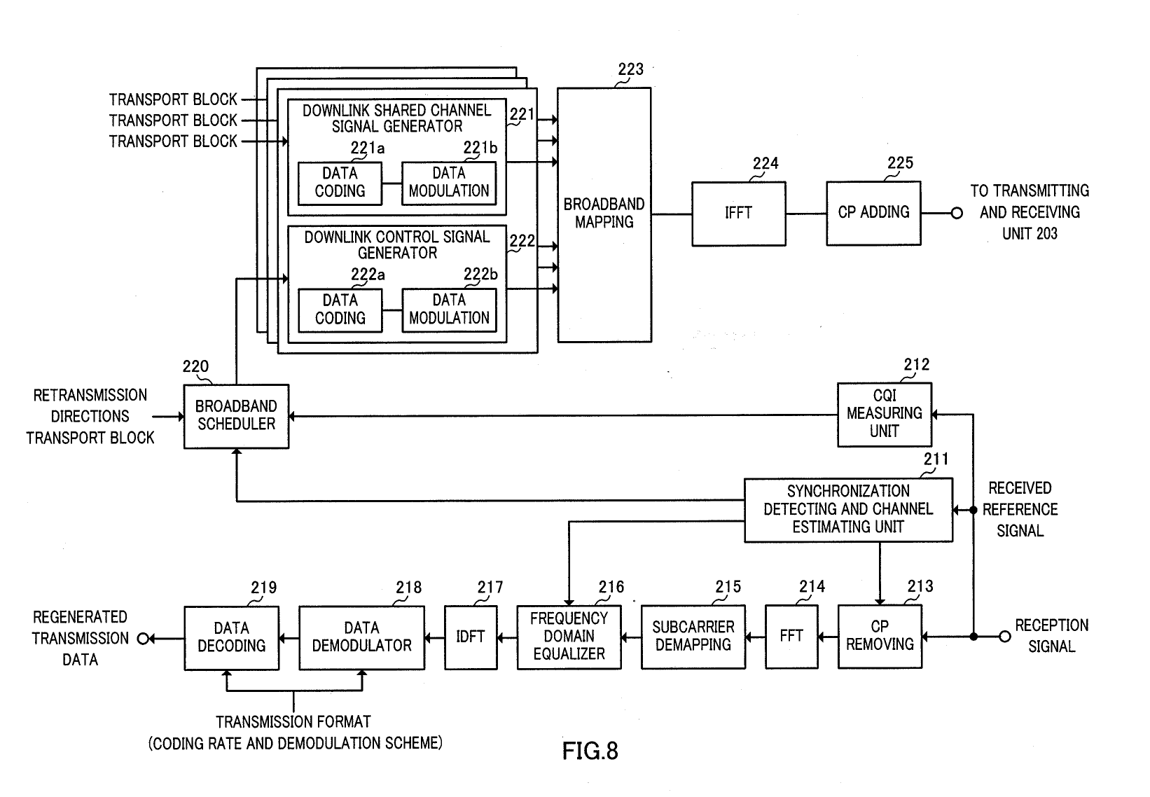

FIG. 8 is a functional block diagram of the baseband signal processing section 204 provided in the base station apparatus 20 according to the present embodiment. The reference signal contained in the reception signal is input to a synchronization detecting and channel estimating section 211 and a CQI measuring section 212. The synchronization detecting and channel estimating section 211 estimates a channel state of the uplink based on a reception status of the reference signal received from the mobile terminal apparatus 10. The CQI measuring section 212 measures a CQI from a broadband quality-measuring reference signal received from the mobile terminal apparatus 10.

On the other hand, the reception signal input to the baseband signal processing section 204 is subjected to removal of the cyclic prefix added to the reception signal at the CP remover 213, Fourier transform at the fast Fourier transform section 214 so that the signal is converted into frequency domain information. The received signal which is converted frequency domain information is demapped into a frequency domain at the subcarrier demapping section 215. The subcarrier demapping section 215 performs demapping in accordance with mapping at the mobile terminal apparatus 10. The frequency domain equalizer 216 equalizes the reception signal based on a channel estimation value given by the synchronization detecting and channel estimating section 211. The inverse discrete Fourier transform section 217 performs inverse discrete Fourier transform on the reception signal so that the frequency domain signal is changed back into a time-series signal. Then, the data demodulator 218 and data decoder 219 perform demodulation and decoding based on transmission formats (coding rate and modulation scheme) to reproduce the transmission data.

A broadband scheduler 220 receives transport blocks (transmission data) and retransmission directions from the higher level apparatus 30 that processes the transmission signal. These retransmission directions contain the bandwidths of group bands as described above and contents for designating the number of group bands that can be assigned to the mobile terminal apparatus 10. On the other hand, the broadband scheduler 220 receives a channel estimation value estimated by the synchronization detecting and channel estimating section 211 and CQIs measured by the CQI measuring section 212. The broadband scheduler 220 uses the retransmission directions input from the higher level apparatus 30 as a basis to perform scheduling of the uplink and downlink control signals and uplink and downlink shared channel signals with reference to these channel estimation value and CQIs. In this case, as described above, the broadband scheduler 220 select specific group bands based on the data rate and reception quality information of all the group bands that make up the system band, and perform scheduling of the transmission data that forms transport blocks to RBs that make up the group bands. Here, this broadband scheduler 220 works as scheduling section.

The downlink shared channel signal generator 221 uses schedule information determined by the broadband scheduler 220 as a basis to generate a downlink shared channel signal using transport blocks (transmission data) from the higher level apparatus 30. In the downlink shared channel signal generator 221, the transport block (transmission data) is coded at the data coding section 221a, modulated at the data modulator 221b and output to the broadband mapping section 223.

The downlink control signal generator 222 uses the schedule information determined by the broadband scheduler 220 as a basis to generate the downlink control signals. In the downlink control signal generator 222, information for downlink control signals is coded at the data coding section 222a, then, modulated at the data modulator 222b and output to the broadband mapping section 223.

Here, in FIG. 8, it is assumed that plural transport blocks (three in this description) transport blocks (transmission data) are received from the higher level apparatus 30 and plural (three) downlink shared channel signal generators 221 and plural (three) downlink control signal generators 222 are provided to support the plural (three) transport blocks. Here, the number of downlink shared channel signal generators 221 and the number of downlink control signal generators 222 are given by way of example and may be changed appropriately in accordance with the number of transport blocks (transmission data) received from the higher level apparatus 30.

The broadband mapping section 223 performs mapping on the downlink shared channel signal input from the downlink shared channel signal generator 221 and the downlink control signal input from the downlink control signal generator 222 to subcarriers. In this case, the broadband mapping section 223 uses schedule information designated by the broadband scheduler 220 as a basis to perform mapping on the downlink shared channel signal and the downlink control signal to subcarriers in selected CC or group band.

The transmission data mapped by the broadband mapping section 223 is subjected to inverse fast Fourier transform at the inverse fast Fourier transform section 224 in which a frequency range signal is converted to a time-series signal. Then, a cyclic prefix is added to the signal at the cyclic prefix adding section (CP adding section) 225. Here, the cyclic prefix serves as a guard interval for absorbing a difference in multipath transmission delay. The transmission data with the cyclic prefix added thereto is sent to the transmitting and receiving section 203.

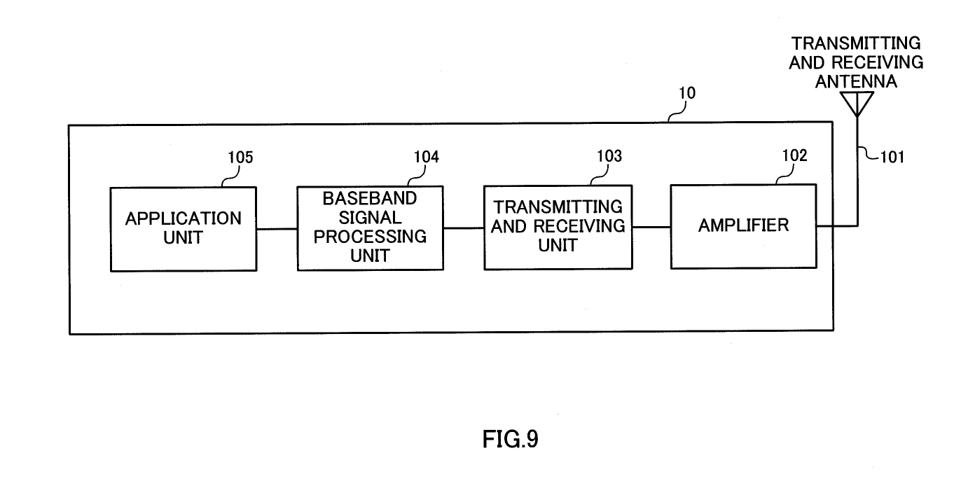

Next description is made, with reference to FIG. 9, about a configuration of the mobile terminal apparatus 10 according to the present embodiment. As illustrated in FIG. 9, the mobile terminal apparatus 10 has a transmitting and receiving antenna 101, an amplifier 102, a transmitting and receiving section 103, a baseband signal processing section 104 and an application section 105.

As to the downlink data, a radio frequency signal received by the transmitting and receiving antenna 101 is amplified by the amplifier 102 and frequency-converted at the transmitting and receiving section 103 into a baseband signal. This baseband signal is subjected to FFT processing, error correction decoding and reception processing of retransmission control and the like at the baseband signal processing section 104. Out of this downlink data, the downlink user data is transferred to the application section 105. The application section 105 performs processing of higher level layer than the physical layer and MAC layer. Besides, out of the downlink data, the broadcast information is transferred to the application section 105.

On the other hand, the uplink user data is input from the application section 105 to the baseband signal processing section 104. In the baseband signal processing section 104, the data is subjected to the transmission processing of retransmission control (H-ARQ (Hybrid ARQ), channel coding, DFT processing, IFFT processing and the like and transferred to the transmitting and receiving section 103. In the transmitting and receiving section 103, the baseband signal output from the baseband signal processing section 104 is subjected to frequency conversion in which the baseband signal is converted into a radio frequency domain signal. Then, the signal is amplified at the amplifier 102 and transmitted via the transmitting and receiving antenna 101.

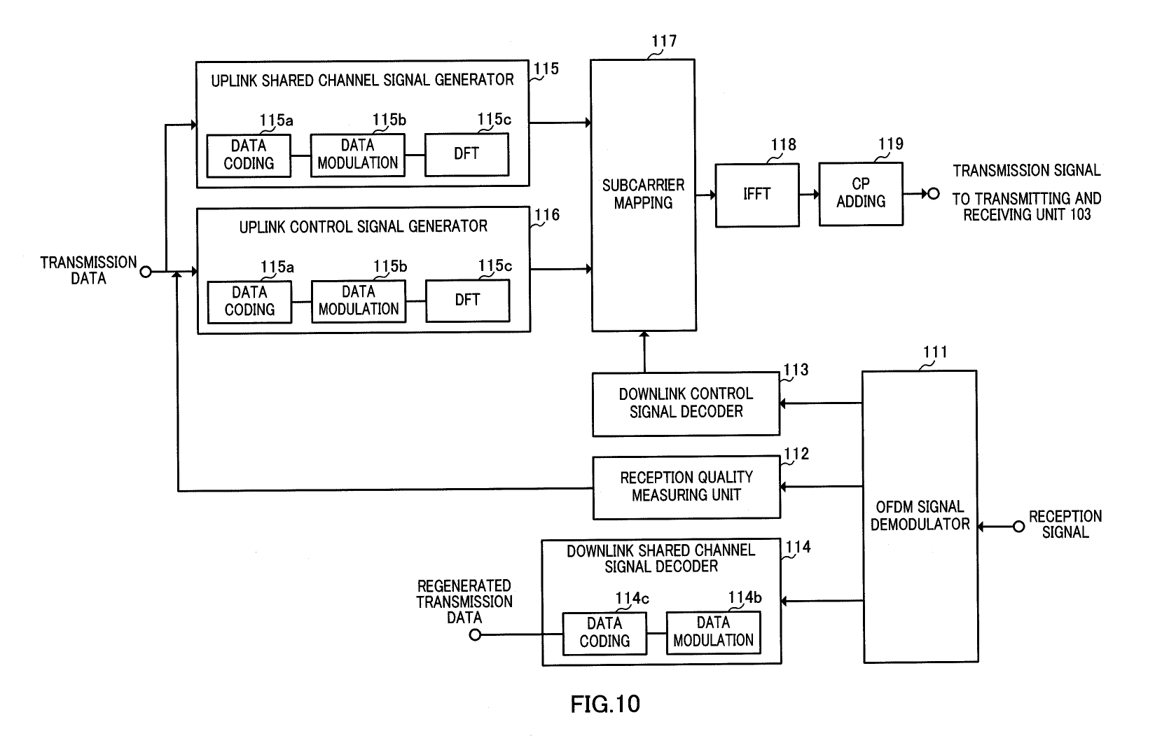

FIG. 10 is a functional block diagram of the baseband signal processing section provided in the mobile terminal apparatus 10 according to the present embodiment. The reception signal output from the transmitting and receiving section 103 is demodulated at the OFDM signal demodulator 111. In the reception quality measuring section 112, the reception quality is measured from the reception state of the received reference signal. The reception quality measuring section 112 measures the reception quality of broadband channels used in downlink OFDM communications by the base station apparatus 20 and communicates the measured reception quality information to the uplink control signal generator 116 described later. In the downlink control signal decoder 113, the OFDM-demodulated downlink reception signal is decoded into a downlink control signal and schedule information contained therein is communicated to the subcarrier mapping section 117 described later. The schedule information contained in the downlink control signal is incorporated into the OFDM demodulation at the OFDM signal demodulator 111. With this structure, in the mobile terminal apparatus 10, it is possible to specify a CC or group band assigned to the mobile terminal apparatus 10 by the base station apparatus 20. In the downlink shared channel signal decoder 114, the OFDM demodulated downlink reception signal is decoded to obtain the downlink shared channel signal. In the downlink shared channel signal decoder 114, the reception signal is demodulated and decoded at the transmission formats (coding rate and modulation scheme) at the data demodulator 114b and the data decoder 114c to reproduce the transmission data.

The uplink shared channel signal generator 115 receives transmission data from the application section 105 and generates an uplink shared channel signal. In the uplink shared channel signal generator 115, the transmission data is coded at the data coder 115a and modulated at the data modulator 115b. then, the data is subjected to inverse Fourier transform at the discrete Fourier transform section 115c in which the time-series information is converted into frequency domain information, which is output the subcarrier mapping section 117.

The uplink control signal generator 116 generates an uplink control signal based on the transmission data received from the application section 105 and reception quality information communicated from the reception quality measuring section 112. In the uplink control signal generator 116, information for the uplink control signal is coded at the data coder 116a and modulated at the data modulator 116b. Then, the data is subjected to inverse Fourier transform at the discrete Fourier transform section 116c so that the time-series information is converted to the frequency domain information, which is output to the subcarrier mapping section 117.

The subcarrier mapping section 117 performs mapping of the uplink control signal input from the uplink control signal generator 116 and uplink shared channel signal input from the uplink shared channel signal generator 115 to subcarriers. In this case, the uplink shared channel signal and the uplink control signal are mapped to the CC or group band designated by the base station apparatus 20 in accordance with the schedule information communicated from the downlink control signal decoder 113.

The transmission data mapped by the subcarrier mapping section 117 is subjected to inverse fast Fourier transform at the inverse fast Fourier transform section 118 so that the frequency domain signal is converted into a time-series signal. Then, in the cyclic prefix adding section (CP adding section) 119 adds a cyclic prefix to the data. Here, the cyclic prefix serves as a guard interval for absorbing a difference in reception timing between plural users in the base station apparatus 20 and multipath transmission delay. The transmission data to which the cyclic prefix is added is output to the transmitting and receiving section 103.

As described up to this point, in the mobile communication system 1 according to the present embodiment, out of a set of group bands obtained by dividing the system band, the base station apparatus 20 selects one or more than one group band based on the reception quality information from the mobile terminal apparatus 10, compares data rates of the overall system obtained after allocating the transmission data to the group bands to select schedule information, perform scheduling of the transmission data in accordance with the schedule information and transmits the data to the mobile terminal apparatus 10 on the downlink. With this structure, as the schedule information is selected considering not only the reception quality information from the mobile terminal apparatus 10 but also data rates of the overall system obtained after allocating the transmission data to group bands selected based on the reception quality information, it is possible to select optimal group bands in the system band for the mobile terminal apparatus 10, thereby enhancing the frequency diversity effect when the system bandwidth is extended and improving the reception quality characteristics in the mobile terminal apparatus 10.

Particularly, when plural group bands are selected based on the reception quality information from the mobile terminal apparatus 10 and data rates calculated for the plural group bands are compared to select schedule information, it is possible to perform scheduling of transmission data to group bands that fall within different CCs. Accordingly, the frequency diversity effect can be enhanced as compared with the case of performing scheduling within a CC and the reception quality characteristics at the mobile terminal apparatus UE can be further improved.

The present invention has been explained in detail by way of the above-described embodiments up to this point. However, it is apparent for a person skilled in the art that the present invention is not limited to the embodiments described here. The present invention may be embodied in modified forms without departing from the scope and subject of the present invention defined by claims. Accordingly, this description has been made merely for illustrative purposes of the present invention and is not intended for limiting the present invention.

For example, the above-described embodiment has been provided by way of example where information is transmitted with a single transmission sequence (transmission stream) from the base station apparatus 20 to the mobile terminal apparatus 10. However, this is not intended for limiting the present invention and the present invention may be modified appropriately. For example, if the base station apparatus 20 has the function of MIMO (Multiple Input Multiple Output), the information transmitting method of the present invention may be applied to the case using plural transmission streams. For example, it can be assumed that the above-mentioned broadband scheduler 220 is provided for each transmission sequence and transmission data that forms transport block is allocated to one or plural group bands. In this case, the above-effect of the present invention can be obtained also in the mobile communication system in which the base station apparatus 20 uses this MIMO function.

Further, the above-described embodiment has been described by way of example where the method of allocating transport blocks in the base station apparatus 20 is applied to the downlink. However, it is not limited to the downlink and may be applicable to the uplink. In this case, in the base station apparatus 20, the CQI measuring section 212 measures the reception quality of the uplink and allocates transport blocks based on this measurement result by the above-described transport block allocating method. Then, the allocation information is incorporated into the downlink control signal, which is then transmitted to each mobile terminal apparatus. In the mobile terminal apparatus 10, the uplink transmission data is transmitted in group bands (for example, CC) designated by this allocation information. In this way, as the transport block allocation method is also applied to the uplink, the effect of the present invention can be also achieved in the uplink.

The present specification is based on Japanese Patent Applications No. 2009-063595 filed on Mar. 16, 2009, the entire contents of which are expressly incorporated by reference herein.

1. A base station apparatus comprising:
scheduling section configured to use reception quality information from a mobile terminal apparatus as a basis to select one or more than one group band from a set of group bands which is provided by dividing a system band and compare data rates of an overall system obtained after allocating of transmission data to the group bands thereby to select schedule information; and
transmitting section configured to transmit the transmission data which is scheduled in accordance with the schedule information to the mobile terminal apparatus on downlink.

2. The base station apparatus according to claim 1, wherein the scheduling section utilizes CQIs as the reception quality information and selects one or more than one group band from the group bands in accordance with averages of a predetermined number of top CQIs in each of the group bands.

3. The base station apparatus according to claim 2, wherein the scheduling section compares the data rates obtained by allocating the transmission data to the group bands selected in accordance with the averages of the predetermined number of different CQIs thereby to select the schedule information.

4. The base station apparatus according to claim 1, wherein the scheduling section selects plural group bands based on the reception quality information from the mobile terminal apparatus.

5. The base station apparatus according to claim 1, wherein each of the group bands is a band that corresponds to a component carrier.

6. An information transmitting method comprising:
a scheduling step of using reception quality information from a mobile terminal apparatus as a basis to select one or more than one group band from a set of group bands obtained by dividing a system band and comparing data rates of an overall system obtained after allocating of transmission data to the group bands thereby to select schedule information; and
a transmitting step of transmitting the transmission data scheduled in accordance with the schedule information to the mobile terminal apparatus on downlink.

7. The information transmitting method according to claim 6, wherein in the scheduling step, CQIs are used as the reception quality information and selection of the group bands is performed in accordance with averages of a predetermined number of top CQIs in each of the group bands.

8. The information transmitting method according to claim 7, wherein in the scheduling step, the data rates are obtained by allocating the transmission data to the group bands selected in accordance with the averages of the predetermined number of different CQIs.
